(19) United States
(12) Patent Application Publication
(10) Pub. No.: US 2007/0008346 A1
(43) Pub. Date: Jan. 11, 2007

(54) DISPLAY DEVICE HAVING PROGRAM IMAGES FILTERING CAPABILITY AND METHOD OF FILTERING PROGRAM IMAGES

(75) Inventors: Fang-Yuan SHYU, Chung-Ho City, Taipei (TW); Kuo-Jui TSAI, Chung-Ho City, Taipei (TW); Shin-Liang CHOU, Chung-Ho City, Taipei (TW)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: AmTRAN TECHNOLOGY CO., LTD, Chung Ho City (TW)

(21) Appl. No.: 11/427,152

(22) Filed: Jun. 28, 2006

(30) Foreign Application Priority Data
Jul. 8, 2005 (TW) 94123299

(51) Int. Cl. G09G 5/00

(52) U.S. Cl. 345/660

(57) ABSTRACT

A display device, having a program images filtering capability and a method of filtering the program images are provided. The display device receives the video signals containing program classification information, that is used to compare and determine if the images of the received video signals should be filtered. When the images of the received program should be filtered, the images of the input video signals are scaled beyond recognition and displayed on the screen of the display device.

This Non-provisional application claims priority under 35 U.S.C. § 119(a) on Patent Application No(s). 094123299 filed in Taiwan, R.O.C. on Jul. 8, 2005, the entire contents of which are hereby incorporated by reference.

### BACKGROUND OF THE INVENTION

1. Field of Invention

The invention relates to a display device, and in particular to a display device having a program images filtering capability and a method of filtering program images.

2. Related Art

In the modern society today, watching TV programs has become one of the most popular entertainments and relaxations. The broadcast of TV programs is realized through the programs coming from the broadcasting channels and the programs from a near end source such as the programs played and provided by video tapes or video disk players.

Nowadays, as TV programs come from multiple and diversified sources, most parents worry about their children being exposed to TV programs with too much sex, crime, and violence, that adversely affect their children's mental health.

Presently, when a TV program is made, the pertinent classification information is built into the program according to the nature of its contents, as such it is classified as restriction-class, guidance-class, protection-class, etc. However, this kind of classification itself is not effective in restricting or preventing the adolescent's access to those TV programs unsuitable for their viewing, since their parents may not be able to stay always by their children's side, guarding and filtering indecent TV programs.

To solve the above-mentioned problems, a kind of TV program filtering technology called V-chip is adopted by the US Government, and it is stipulated that effective

Jan. 1, 2000, such a V-chip technology must or had to be built-in all TV sets with screen sizes above 13 inches. As such, various V-chip solutions have been proposed. For instance, U.S. Pat. No. 4,930,160, wherein a video program receiving method is disclosed, in which a classification code attached with a program is compared with the contents pre-stored in a memory device. If the results of the comparison is affirmative, then the program is displayed, otherwise an alternative program coming from another video signal source is selected and displayed instead of the program from the original video signal source.

In U.S. Pat. No. 5,583,576, another technology is disclosed; if a certain program received is not allowed to be displayed, then a program list is displayed on the screen informing the viewers of other channels that are allowed to be displayed.

In U.S. Pat. No. 6,519,770 is disclosed a technology which is utilized to interfere with the program that is not allowed to be displayed, such as the image distortion, thin-out, overlapping, scrambling, blank image or other pre-stored image/character messages, are used to cover and replace the original images to be displayed. Audio-signal-side, the program is switched to silent or is replaced with a pre-recorded audio program. However, in the above-mentioned technologies, the display of a blank image may mislead the viewers to misinterpret that the TV set is shut-down, malfunctioning or there are problems with the program source. Moreover, the distortion and thin-out of images may not be effective enough to completely filter out the images to the extent of disabling from being recognized by the viewers and the distortion of images may even lead to the visual discomfort of the viewers. Besides, the application of an alternative program source, the overlapping or scrambling of images, or utilizing the pre-stored images or character messages to cover and replace original images, all these measures necessitate the utilization of additional circuits or additional memory devices, that would increase the production cost of TV sets, and thus are detrimental to the business competitiveness of the manufacturers. Therefore, the research and development of a lower cost and more efficient program images filtering technology is presently the most important and urgent task in this field.

### SUMMARY OF THE INVENTION

The invention relates to a display device having a program images filtering capability and a method of filtering program images, and it is utilized to filter the video signals of the received program. When it is determined this program should not be displayed, the images of the received video signals are scaled beyond of recognition and then displayed.

The invention discloses a display device having a program images filtering capability containing at least a program classification table, which is utilized to compare and determine if the program is allowed to display upon receiving the video signals of the program. The display device includes a displayer, used to display images of the received video signals; a classification information acquiring module, used to retrieve classification information from the video signals; a program classification table module, containing at least a program classification table, which is designed to have the program classification corresponding to the classification information and the settings specifying whether the program should be filtered or not; a comparison and verification module, used to compare said classification information with classifications of said classification table, and issue a verification signal indicating if the classification information corresponds to the classification settings; an image scaling module, used to receive a video signal and scale the images of the received signal as required and then display them on the display device. Meanwhile, it is utilized to receive the verification signal, if the signal indicates that the classification information does not correspond to the classification setting, indicating the program should be filtered, then the module is used to perform the regular image scaling of the video signal for normal viewing, otherwise the image of the video signal is scaled beyond of recognition and displayed.

The invention also discloses a display device having a program images filtering capability and a method of filtering program images, said display device contains at least a program classification table, which is used to verify if the program should be filtered. The method includes the following steps: receiving the video signals and obtaining from them the related classification information; comparing the classification information with the contents of the program classification table, thus generating a verification signal; when it is determined that the classification information corresponds to the program classification setting in the program classification table, such, that the program should be filtered by scaling the images of the video signal beyond of recognition and then displaying them.

Further scope of the applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention and constitute a part of this specification, illustrate embodiments of the invention and together with the description serve to explain the principles of the invention. In the drawings:

FIG. 1 is a system block diagram of a display device having a program images filtering capability according to an embodiment of the invention; and

FIG. 2 is a system flowchart of the program images filtering method according to an embodiment of the invention.

### DETAILED DESCRIPTION OF THE INVENTION

Reference will now be made in detail to the embodiments of the invention, examples of which are illustrated in the accompanying drawings.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

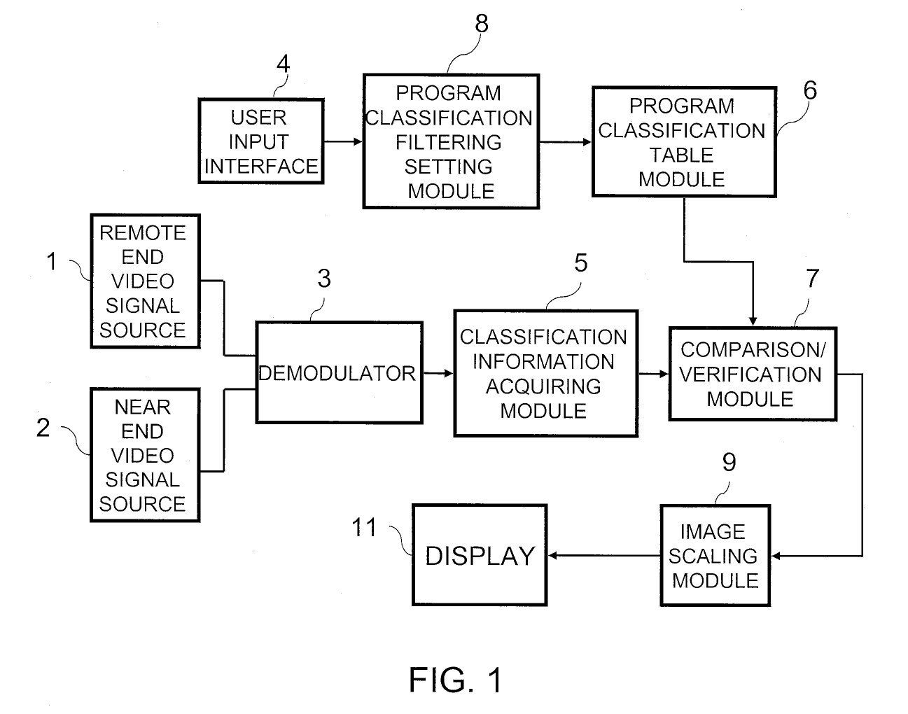

Refer to FIG. 1, which shows the system block diagram of a display device having a program images filtering capability according to an embodiment of the invention. The crux of the invention is that the images of the received program, scaled beyond of recognition if its classification, are determined to be restrictive-class and then displayed.

As shown in FIG. 1, the display device, having a program images filtering capability according to an embodiment of the invention includes: a demodulator 3, a program classification information acquiring module 5, a program classification table module 6, a comparison & verification module 7, an image scaling module 9, and a displayer 11. The functions of the respective above-mentioned modules are well known to people familiar with the art, and can be realized by means of hardware, software or the combination of software and hardware. The functions and constructions of each of the above-mentioned devices will be described in detail as follows.

In an embodiment as shown in FIG. 1, a remote end video signal source 1 and a near end video signal source 2 are provided, and are utilized to serve as the sources of video signals of the invention, which is displayed on the displayer II after the appropriate processing required.

The remote end video signal source 1 can be any suitable and proper equipment, for example a wired TV program source connected through a coaxial cable or an optical fiber cable as well as the related control circuit, satellites or TV program broadcasting sources, transmitting programs to the control circuits through the atmosphere, file servers distributing TV programs to the control circuit through the network, or any other appropriate video program signal source.

The near end video signal source 2 can be part of the device of the invention, for example, a cassette type tape recorder player, disc player, or any other device suitable for playing video movie programs.

The video signal from remote end video signal source 1 or remote end video signal source 2 may contain a classification identification code, which is used to indicate the nature, address and classification information of a movie program containing the video signals. For example, a movie program may be classified as sex-rated or violence-rated according to the extent of sex or violence in that movie program.

The coding process of this classification identification code usually is done by the movie program producer during a certain period of the program generation process, and the coding information can be processed and stored in the storage medium of the movie program in parallel with the data flow of the video signals. The type of coding technology utilized is related to the nature of the recording medium, such as a video tape, CD, DVD, digital disc or digital movie server.

The demodulator 3 is used to receive the video signals of the movie program desired to view by the user from a remote end video signal source 1 or a near end video signal source 2. As mentioned earlier, coded classification information is contained in these video signals. The demodulator 3 is utilized to demodulate the received video signals, and if necessary, the demodulator 3 may be provided with a digital signal processing capability thus processing the digital video signals received.

The classification information acquiring module 5 is used to separate the classification information from the video signals received by the demodulator 3, and provide it to the comparison & verification module 7 to be compared to and verified with the contents of the program classification table.

The program classification table module 6 includes at least a program classification table and which provides with various program classifications corresponding to the classification information. A well-known example of said program classification table is the TV program classification table including the following classifications:

TV-Y: for all children;

TV-7: for older children;

TV-G; for general public;

TV-PG: parental guidance required;

TV-14: intense parental attention required;

TV-MA: adults only.

Other types of program classification table may include, for example, the following Classifications made by the MPAA regarding movie programs:

G: general class, for ordinary audience
PG: protection class, parental guidance required;

PG13: guidance class, intense care of parents required;

R: restricted class, adults company & guidance required for age under 17;

NC-17: restricted class, not allowed for age under 17;

X: restricted, for adults only.

In the program classification table mentioned above, the respective program classifications correspond to the respective filtering settings used in determining if the program is to be filtered. When it is determined that a program should be filtered according to a specific filtering setting, the images of the video signals of the program corresponding to classification are filtered and will not be displayed and thus will not be viewed by the viewer. In other words, in principle, the programs are classified into two categories: ‘filtered’ or ‘not-filtered’, corresponding to the respective filtering settings in the classification table. In another embodiment of the invention, a user input interface 4 and a program classification filtering setting module 8 are provided in said program classification table module 6, which may be used by the user to revise the filtering settings in the program classification table module 6, thus determining if a specific program should be filtered. For example, if the filtering settings for all the classifications are cancelled, then images of the programs for all classifications can be viewed, or the filtering settings may be modified such, that except for the general classification, the images of programs of all other classifications are filtered.

However, said two modules are optional depending on the actual requirements and are not absolutely necessary. For instance, if the filtering settings for the respective classifications in the program classification table module 6 are all fixed and well set already and there is no need for further revisions, then the user input interface 4 and the program classification filtering setting module 8 can be omitted.

In case the option and function of the user input interface 4 and the program classification filtering setting module 8 are selected, the user may make revisions to the respective program classification filtering settings in a program classification table of the program classification table module 6 through the user input interface 4. For instance, the user may use the user input interface 4, such as a remote controller interface or an operation interface installed on a display device to make personalized revisions of the filtering settings, then it is compared with the program classification information of the received video signals to determine if the program should be filtered. If the answer is affirmative, then the images of the video signals of the received program are scaled beyond of recognition and displayed. Upon receiving the instructions, input by the user through the user input interface 4, the program classification filtering setting module 8 then proceeds with the revision and updates the filtering settings corresponding to the program classification in the program classification table of the program classification table module 6.

The comparison and verification module 7, used to compare the classification information with the program classification in the program classification table upon receiving the classification information retrieved from the received video signals, and output a verification signal indicating if the classification information matches the program classification in the program classification table such that the program should be filtered.

The image scaling module 9, used to receive the verification signal output from the comparison & verification module 7, and scale the images of the received video signals according to the filtering settings obtained as a result of the comparison and verification, and then display them on the display device. It should be noted that, the images of the input video signals may be scaled to any appropriate size and proportion by the image scaling module 9 as long as they are beyond of recognition. In real practice, the image scaling module 9 can be, for example, the scalar of the prior art, yet it is not limited to this.

In the above description, if the verification signal indicates that the classification information does not match with the program classification of the program classification table, then the image scaling module 9 is used to perform the regular image scaling of the video signals for normal viewing. However, if the verification signal indicates that the classification information matches the program classification of the program classification table, then the image scaling module 9 is used to scale the images beyond of recognition.

The displayer 11, used to display the images of the input video signals after scaling, may be a standard TV set or a display device having sound broadcasting capability. However, the sound broadcasting capability may be performed by a separate loudspeaker. The displayer may be a CRT display, a liquid crystal display, or a PDP display.

Therefore, according to the invention, the image-scaling module 9 is used to scale the images of the input video signals to a regular size and proportion for normal viewing or scale the images beyond recognition according to the verification signal output from the comparison & verification module, and display them on the displayer 11.

The display device, having the program image filtering capability of the invention can be built in a set-top-box, and may include the pertinent software required to implement the features of the invention. In addition, the display device of the invention may be a stand-alone type device or it may be attached to a personal computer to implement its functions.

Regardless of what kind of hardware device the display device of the invention may belong to, the user may execute his control of the display device of the invention by inputting data through the user input interface. The appropriate user interface may include: a wireless remote controller, a pointing device such as a mouse or track ball, a sound recognition device, a touch control panel, a press key, etc.

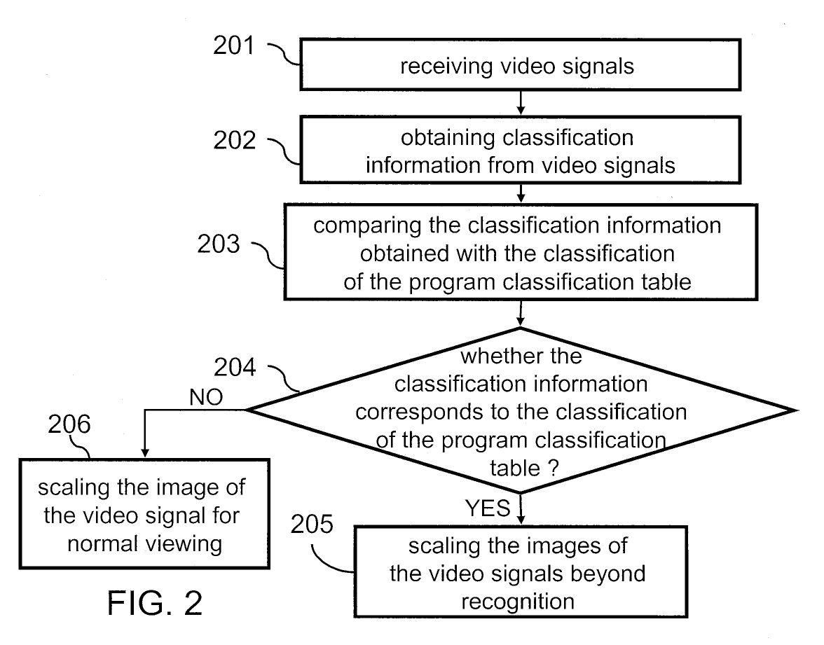

Subsequently, refer to FIG. 2 for a system flowchart of the program image filtering method according to an embodiment of the invention.

Firstly, receiving video signals of a movie program from a remote end or near end video signal source (step 201). Next, retrieving the program classification information from the received video signals (step 202). Then, comparing the program classification information thus obtained with the contents of the program classification table (step 203), and determining if the program classification information retrieved from the input video signals matches the program classification in the program classification table (step 204). If the answer is affirmative, scale the images of the input video signals beyond of recognition (step 205); otherwise, scale the images of the input video signals to regular sizes and proportions for normal viewing (step 206). In the above process of image scaling, the images are scaled according the pre-set ratios, such, that the images may be scaled for normal viewing or may be scaled beyond of recognition.

Through the application of the method and device of the invention, the input video signals of the movie program received from a remote or near end video signal source can be classified and filtered, and then the images of the video signals can be scaled depending on the classifications, to achieve the objective of filtering the program. Since the program filtering is achieved by merely scaling the images of the received input video signals, there is no need to do other complicated processing of the images (for example, overlapping, replacement, or distortion) as done in the prior art, as such there is no need for additional circuits or memory devices. In addition, since, during program filtering, only the sizes of the images are varied and there is no distortion of the images, this will not cause the visual discomfort of the viewers. Therefore, the implementation of the invention may have the benefit of saving hardware storage space, reducing the production cost of the display device, and personalized design and application.

Although the invention has been explained by the embodiments shown in the drawings described above, it should be understood to the person skilled in the art that the invention is not limited to these embodiments, but rather various changes or modifications thereof are possible without departing from the spirit and scope of the invention. Accordingly, the scope of the invention shall be determined only by the appended claims and their equivalents.

What is claimed is:

1. A display device having program images filtering capability, the display device receiving the video signals containing program classification information, that is used to compare and determine if the images of the received video signals should be filtered, comprising:
a display for displaying the images of the received video signals;
a classification information acquiring module for obtaining the program classification information from said video signals;
a program classification table module, containing at least a program classification table, which includes the respective program classifications corresponding to said program classification information and the filtering settings specifying if the program should be filtered;
a compare and verification module for comparing said program classification information with the classifications of said program classification table, and outputting a verification signal indicating if said program classification information corresponds to said program classification and thus requiring program filtering; and
an image scaling module for receiving said video signals and display them on the displayer after the image scaling is required, said image scaling module receiving said verification signal, and if the verification signal indicates that said program classification information does not correspond to said program classification, then perform the regular image scaling for normal viewing, otherwise scale the images beyond of recognition thus to achieve the filtering of the program.

2. The display device of claim 1, further comprising a program classification filtering setting module for modifying the filtering settings in said program classification table specifying that if the program should be filtered.

3. The display device of claim 2, further comprising a user input interface for inputting data to modify the filtering settings corresponding to the program classifications specifying that if the program should be filtered.

4. The display device of claim 1, further comprising a demodulator for demodulating said video signals received from a remote end video signal source or a near end video signal source.

5. The display device of claim 1, wherein said display is selected from the group consisting of a CRT display, a LCD display, and a PDP display.

6. A program images filtering method of a display device, said display device is provided with a program classification table, which is used to compare and determine if a program is allowed to be displayed upon receiving its video signals, comprising the following steps:
obtaining the classification information from said received video signals;
comparing said classification information with the program classifications contained in said program classification table thus to generate a verification signal; and
if said verification signal indicates that said classification information corresponds to said classification of said program classification table, thus determining that the program should be filtered and scaling the images of said video signals beyond of recognition.
